(19) United States
(12) Patent Application Publication
(10) Pub. No.: US 2025/0113132 A1
(43) Pub. Date: Apr. 3, 2025

(54) THIN PANEL SURFACE MOUNT MICROPHONE

(71) Applicant: Harman International Industries, Incorporated, Stamford, CT (US)

(72) Inventor: Yu Du, Chicago, IL (US)

(73) Assignee: Harman International Industries, Incorporated, Stamford, CT (US)

(21) Appl. No.: 18/478,325

(22) Filed: Sep. 29, 2023

(51) Int. Cl. H04R 1/08; H04R 1/22

(52) U.S. Cl. CPC H04R 1/086; H04R 1/222; H04R 2499/13

(57) ABSTRACT

A sound and vibration sensor having a sealed cavity defined between a microphone element and structure panel and an area below the microphone element wherein the microphone element senses a change in acoustic pressure inside the sealed cavity caused by sound waves striking the structure panel.

### TECHNICAL FIELD

The present disclosure relates to a sound sensing device and more particularly, to a surface-mounted and environmentally sealed sound sensing device.

### BACKGROUND OF THE INVENTION

With the growth of driving assistance technologies and autonomous driving vehicles, the number of sensors on a vehicle has grown extensively. As a result of the development of these technologies, it has become necessary to sense sound from outside the vehicle. Currently, sound sensing devices are being positioned on an exterior structure panel (e.g., body panel, frame, glass) of the vehicle that is directly exposed to various types of harsh environmental conditions such as water and dust ingress and close-range high temperature, high pressure spray (up to 85° C. and 10 MPa) as described by the IP6K9K rating in ISO 20653.

To achieve good acoustic performance, such as high sensitivity and wide bandwidth, a microphone element, by design, requires a port hole to provide a direct air path between the sensing element and the external environment. This makes the microphone element susceptible to damage caused by harsh environmental conditions or foreign contaminants.

One approach to address the problem is to add acoustic mesh or acoustic membrane in front of the port hole of a microphone element. The acoustic mesh or membrane is often made from materials (or structures) that have very small pore sizes, or micropores, that are typically several to several hundred micrometers in diameter. The micropores are big enough to allow air molecules to pass through yet are small enough to block dust particles. It is also difficult for liquid molecules to pass through due to the large surface tension formed among liquid molecules, thus making it waterproof. Therefore, the acoustic mesh or acoustic membrane forms a physical layer to isolate and protect the delicate sensing element from the external environment. Examples of acoustic mesh or membrane materials are PTFE (polytetrafluoroethylene) and PDMS (polydimethylsiloxane).

It should be noted that although the terms of acoustic mesh and acoustic membrane may be used interchangeably, the subtle difference between them is that mesh often refers to materials (or structures) with larger pore sizes whereas membrane often refers to materials (or structures) with smaller pore sizes. Nevertheless, to be acoustically breathable and not to significantly degrade the acoustic performance of the microphone, such an acoustic mesh or membrane needs to be thin, flexible, and low in mass, which could make it easily damaged by sharp objects (e.g., road debris). In addition, when pressurized, liquids like water may penetrate through the pores, making it impossible to meet the IPx9K rating under high pressure high temperature spray.

Another approach to address the problem is to attach an accelerometer to a structure surface (e.g., glass window or door panel of a vehicle) to measure the sound induced vibration of the panel that correlates with and represents the sound in the environment. Since, by design, accelerometers are entirely sealed to the environment, this approach solves the weatherproof problem perfectly. An example of such an accelerometer-based sound sensing solution using piezo-diaphragms can be found in a recent U.S. Pat. No. 11,533,568B1. However, piezo diaphragms are typically much larger in size than a microphone element (e.g., a MEMS or ECM microphone element) making it more difficult to integrate them into a protective housing while achieving good electromagnetic interference and electromagnetic compatibility (EMI/EMC) performance.

There is a need for a surface mounted sound sensing device that, when mounted to the surface, creates a seal around a microphone element of the sound sensing device to weatherproof the sound sensing device and still achieve good acoustic performance.

### SUMMARY OF THE INVENTION

A sound and vibration sensor having a housing, a PCBA attached to a perimeter edge inside the housing, an adhesive member sealed to both a perimeter edge of one end of the housing and a structure panel defining a sealed cavity wherein a microphone element senses a change in acoustic pressure inside the sealed cavity caused by sound waves striking the structure panel.

In one or more embodiments, a leak channel in the PCBA creates a ventilation path between the sealed cavity and a cavity inside the housing.

In one or more embodiments, the structure panel is thinned in an area that receives the adhesive member. The thinned area may be configured to match an outer perimeter of the adhesive member.

In one or more embodiments, the structure panel is a vehicle body panel. The adhesive member may adhere to a B-side of the vehicle body panel.

In one or more embodiments, the PCBA is flush-mounted at one end of the housing and a thickness of the adhesive member defines a small gap distance.

In one or more embodiments, the sound and vibration sensor has a vent in the cavity inside the housing to balance static air pressure.

In one or more embodiments, the vent is covered with a dense mesh layer.

### BRIEF DESCRIPTION OF DRAWINGS

The features, objects, and advantages of the present disclosure will become more apparent from the detailed description hereinafter when taken in conjunction with the drawings, in which like reference numbers refer to like elements.

FIG. 1A is a cut away view of one or more embodiments of a sound sensing device prior to being mounted to a structure panel;

FIG. 1B is a cutaway view of the sound sensing device shown in FIG. 1A mounted to a thin panel surface;

FIG. 2 shows exemplary locations for mounting the sound sensing device on a vehicle;

FIG. 3 is a cutaway view of one or more embodiments of the sound sensing device; and

FIG. 4 is a cutaway view of one or more embodiments of the sound sensing device.

### DETAILED DESCRIPTION OF THE INVENTION

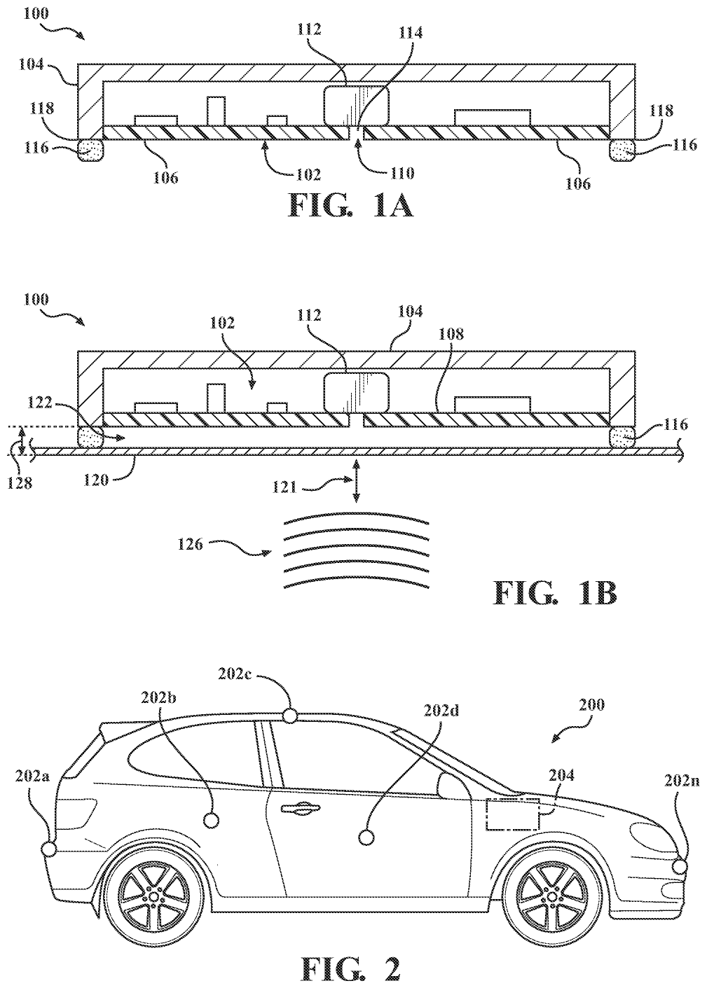

FIG. 1A is a cut away view of a sound sensing device 100 according to one or more embodiments. A printed circuit board assembly (PCBA) 102 is flush mounted inside a housing 104 at one end of the housing 104 so that a water-tight seal is created between the housing 104 and a perimeter edge 106 of the PCBA 102.

The PCBA 102 is a printed circuit board (PCB) 108 having a port hole, or an aperture, 110 and includes any components needed for the sound sensing device 100 to operate. Other circuit components may include, but are not limited to, a preamplifier, an analog-to-digital converter, a microphone element 112, and any other components necessary for the sound sensing device to operate. The microphone element 112 has an acoustic port 114 and is mounted on the PCB 108 so that the acoustic port 114 is aligned with the port hole 110 on the PCB 108 to allow sound waves external to the sound sensing device 100 to reach a first diaphragm (not shown) that is exposed via the acoustic port 114 of the microphone element 112. In one or more embodiments, the microphone element 112 may be a micro-electro-mechanical system (MEMS) device. In one or more embodiments, the microphone element 112 may be an electret condenser microphone (ECM) device. In one or more embodiments, the sound sensing device 100 may include an adhesive member 116 shaped in a manner that matches an outer perimeter of the housing 104. In one or more embodiments, the adhesive member 116 is shaped as a ring, for example, as in the case of a circular housing 104.

FIG. 1B is a cut away view of the sound sensing device 100 mounted to a structure panel 120. The adhesive member 116 aligns with and attaches to a bottom perimeter 118 of the housing 104 while also attaching to and creating a seal with the structure panel 120, for example, a vehicle body panel. When the sound sensing device 100 is used on an automotive vehicle, the adhesive member 116 should be strong and durable for typical automotive applications and should be able to withstand extreme temperatures and humidity. Additionally, or alternatively, the adhesive member 116 may be conformable, for example, having a foam core, to ensure good contact, thus good seal, is achieved between surfaces that may be even just slightly mismatched.

Good contact of the adhesive member 116 to the housing 104, good contact of the adhesive member 116 to the structure panel 120, and a thickness, h, of the adhesive member 116 create a sealed cavity 122 between the structure panel 120 and a bottom surface 124 of the PCBA 102. The sealed cavity 122 defines a first sealed volume, V1, based on the thickness, h, of the adhesive member 116 and the dimensions of the housing 104. Mounting the sound sensing device 100 to the structure panel 120 in a manner that is sealed, by way of the adhesive member 116, creates a surface mounted microphone. When sound waves 126 strike the structure panel 120, surface vibration 121 in the form of displacement (or velocity or acceleration) is induced in a direction perpendicular to the structure panel 120. Displacement of the structure panel 120 dynamically changes the first sealed volume, V1, generating acoustic pressure that is proportional to the volume change inside the sealed cavity 122 that is sensed by the microphone element 112. The structure panel 120 behaves as a second diaphragm for sound sensing. A first diaphragm (not shown) is inside the microphone element 112.

An advantage of the inventive subject matter is that the sound sensing device 100 uses the structure panel 120 to seal the cavity 122 and provide environmental protection for the microphone element 112 of the sound sensing device 100. In the example of an automotive application, a vehicle body panel made of sheet metal (e.g., steel or aluminum alloy) or plastic is undoubtably strong enough to meet the IP6K9K protection rating.

Sensitivity, frequency response characteristics, and bandwidth of the sound sensing device 100 may be determined by the volume, V1, of the sealed cavity 122, an area of the structure panel 120 that is enclosed by the adhesive member 116, a material property of the structure panel 120, and a thickness of the adhesive member 116. To increase sensitivity, a smaller sealed cavity, 122, or first sealed volume, V1, is preferred. This requires a small gap distance 128 between the structure panel 120 and the bottom surface 124 of the PCBA 102. A thicker adhesive member 116 will create a larger sealed cavity 122 and a thinner adhesive member will create a smaller sealed cavity 122.

On the other hand, a larger enclosed area helps introduce higher volume change in the cavity 122. Therefore, for a circular sound sensing device 100, an enclosed area equivalent to a circular area of a diameter between 10 mm and 80 mm may be preferred.

A total volume of the sealed cavity 122 may be kept below 350 mm³. The gap distance, 128, mostly controlled by the thickness of the adhesive member 116, may be preferably between 0.1 and 0.5 mm. Finally, automotive body panels are typically 0.5 mm to 2 mm thick depending on the type of material (e.g., steel panel is thinner). This thickness range, combined with the preferred ranges of the enclosed area, the gap distance 128, and the sealed cavity 122 volume, V1, is suitable to generate sufficient acoustic pressure in the small, sealed cavity 122 under the excitation of typical external sound pressure levels in the environment (e.g., on the order of 50-120 dB sound pressure level (SPL)).

FIG. 2 shows a vehicle 200 exemplary locations 202a-202n for mounting the sound sensing device on the vehicle 200. More than one sound sensing device may be positioned on the vehicle, and the locations may be selected depending upon the sounds being targeted for detection. For example, but not limited to the sound sensing device being surface-mounted for external or internal voice detection to transmit signals indicative of voice commands to one or more controllers 204 on the vehicle. The one or more controllers 204 may be responsible for activating or deactivating a vehicle operation (e.g., open/close a trunk, door, liftgate, etc.). Additionally, or alternatively, and not limited to, the sound sensing device may be used in connection with detecting background noise signals that may be used by one or more controllers 204 in an active noise cancellation (ANC) and/or road noise cancellation (RNC) system. The microphone element (not shown in FIG. 2) may include an analog, or a digital, interface, such as A2B, to communicate with the one or more controllers 204 on the vehicle 200.

The sound sensing device may be mounted on any thin structure panel of the vehicle 200 such as a door panel, a roof panel, a front/rear bumper panel, etc. Additionally, or alternatively, the sound sensing device may be mounted to an inner facing side, B-side, of the structure panel to entirely hide the device from view.

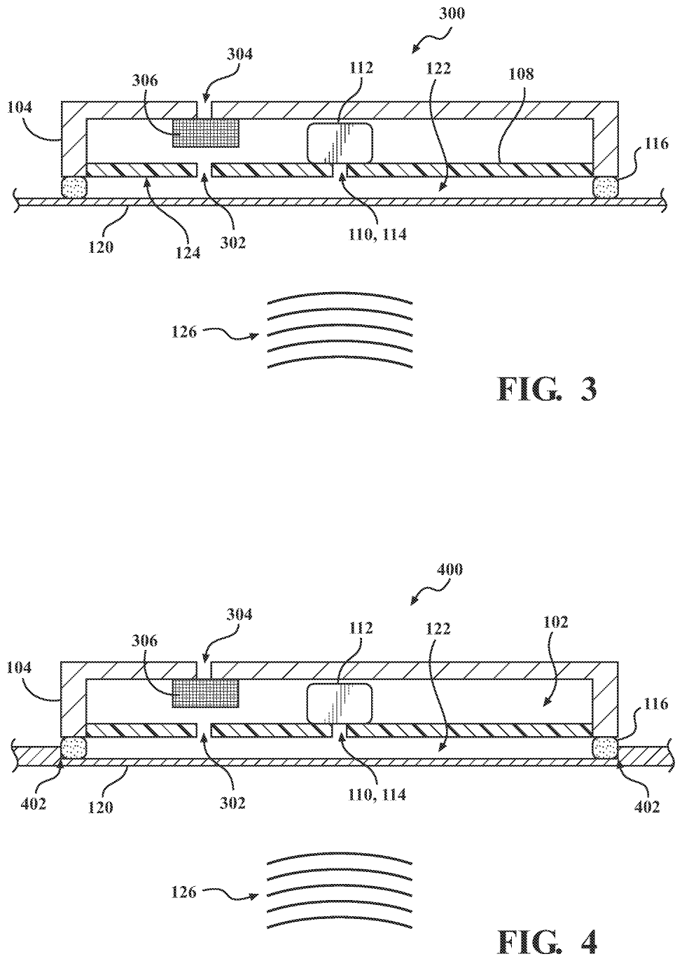

Altitude or environmental temperature changes may cause static pressure differences to occur between the cavity 122 and the external environment. Static pressure differences may pre-stress the structure panel 120 leading to unwanted changes in sensitivity and frequency response characteristics. FIG. 3 is a cutaway view of one or more embodiments of the sound sensing device 300 having a leak channel 302 in the PCBA 102 and a vent 304 in the housing 104. The leak channel 302 and the vent 304 define a ventilation path connecting the cavity 122 to the external environment wherein the ventilation path balances static air pressure between the cavity 122 and the external environment.

For minimal effect on a low frequency response of the microphone element 112, a cross-sectional area of the leak channel 302 should be kept as small as possible. For example, a circular (or equivalent) area with a diameter smaller than 0.4 mm. The vent 304 in the housing may have a circular (or equivalent) area with a diameter smaller than 1 mm.

Optionally, a dense mesh layer 306 may be positioned inside the housing 104 to cover the vent 304. The dense mesh layer 306 may have even smaller pore sizes than an air breathable acoustic mesh to not only prevent foreign objects, water, and moisture from entering the housing, and ultimately the microphone element 112 but also present high resistance for air molecules to pass through. Yet the dense mesh layer 306 still allows static pressure equalization when a difference between the internal and external static air pressure becomes large. An exemplary dense mesh layer 306 may be made of expanded polytetrafluororethylene (ePTFE) material with a thickness in a range of 0.1 to 0.5 mm.

FIG. 4 is a cutaway view of one or more embodiments of a sound sensing device 400 that has a shape that matches a pre-molded, or built-in, recessed area 402 on the structure panel 120. An advantage is that the recessed area 402 of the structure panel that receives the adhesive member 116 of the sound sensing device is thinner than the surrounding body panel thereby increasing a sensitivity and a signal-to-noise ratio (SNR) of the sound sensing device 400. The recessed area 402 also helps to ensure that the sound sensing device 400 is positioned and mounted to the proper location on the vehicle body during assembly.

The sound sensing device 100, 300, 400 of the inventive subject matter attaches onto a structure panel 120 such as a vehicle body panel, providing an environmentally sealed surface mounted microphone suitable for external microphone applications. Attaching the sound sensing device to the structure panel in a fully sealed manner not only environmentally protects the microphone element, but the structure panel 120, 420 acts as a second diaphragm for the microphone element 112.

An advantage over traditional microphones for use on an exterior of an automotive vehicle, is that the sound sensing device 100, 300, 400 has a fully sealed attachment to the structure panel ensuring that the sound sensing device 100, 300, 400 will be able to meet the highest ingress protection rating (e.g., IP6K9K). Yet another advantage that the sound sensing device 100, 300, 400 presents over traditional microphones, is that the sound sensing device 100, 300, 400 is integrated into vehicle structures, by way of the adhesive member, allowing it to be used externally, yet remaining totally hidden, for aesthetic reasons.

An advantage over piezo-diaphragm is that the sound sensing device 100, 300, 400 is much smaller in size, in thickness and in height than the piezo-diaphragm. The device 100, 300, 400 may be integrated into a much smaller module housing 104 and provide improved EMI/EMC performance.

What is claimed is:

1. A sound and vibration sensor comprising:
a housing;
a printed circuit board assembly (PCBA) including a microphone element, the PCBA being attached to a perimeter edge within the housing; and
an adhesive member having a first side adhered, in a sealed manner, to a perimeter edge of one end of the housing, the adhesive member having a second side adhered, in a sealed manner, to a structure panel; and
a sealed cavity defined between the structure panel and an area below the PCBA;
wherein the microphone element senses a change in acoustic pressure inside the sealed cavity caused by sound waves striking the structure panel.

2. The sensor as claimed in claim 1, further comprising a ventilation path created by a leak channel in the PCBA between the sealed cavity below the PCBA and an area of the housing above the printed circuit board assembly and a vent in the housing above the PCBA.

3. The sensor as claimed in claim 2, wherein the leak channel further comprises a circular cross-sectional area less than 0.4 mm in diameter and the vent further comprises a circular cross-sectional area less than 1.0 mm.

4. The sensor as claimed in claim 2, further comprising a dense mesh layer covering the vent.

5. The sensor as claimed in claim 1, wherein a portion of the structure panel that receives the second side of the adhesive member is thinned in comparison to surrounding structure panel.

6. The sensor as claimed in claim 5, wherein an outer perimeter of the thinned structure panel is configured to match an outer perimeter of the adhesive member to receive the adhesive member in a fully sealed manner.

7. The sensor as claimed in claim 1, wherein the adhesive member has a conformable foam core.

8. The sensor as claimed in claim 1, wherein the structure panel is a vehicle body panel.

9. The sensor as claimed in claim 8, wherein the second side of the adhesive member is adhered to a B-side of the vehicle body panel.

10. A surface-mounted microphone module, comprising:
a housing;
a printed circuit board assembly (PCBA) having an aperture, a perimeter edge of the PCBA is flush-mounted inside the housing at one end of the housing;
a microphone element mounted to the PCBA, the microphone element has an acoustic port aligned with the aperture of the PCBA; and
an adhesive member having a first side that is adhered, in a sealed manner, to an outer perimeter of the housing at one end of the housing below the PCBA, the adhesive member has a second side that is adhered, in a sealed manner, to a structure panel defining a sealed cavity;
wherein when sound waves strike the structure panel, surface vibration in a form of displacement in a direction perpendicular to the structure panel is induced and dynamically changes a volume of the sealed cavity thereby generating acoustic pressure that is proportional to a change in volume inside the sealed cavity, the acoustic pressure is sensed by the microphone element.

11. The module as claimed in claim 10, further comprising a ventilation path created by a leak channel in the PCBA and a vent in the housing.

12. The module as claimed in claim 11, wherein the leak channel is aligned with the vent.

13. The module as claimed in claim 11, further comprising a dense mesh layer covering the vent.

14. The module as claimed in claim 10, wherein an area of the structure panel that receives the second side of the adhesive member is thinned in comparison to surrounding structure panel.

15. The module as claimed in claim 14, wherein an outer perimeter of the thinned structure panel is configured to match an outer perimeter of the adhesive member to receive the adhesive member in a fully sealed manner.

16. The module as claimed in claim 10, wherein the adhesive member has a conformable foam core.

17. The module as claimed in claim 10, wherein the structure panel is a vehicle body panel.

18. The module as claimed in claim 17, wherein the second side of the adhesive member is adhered to a B-side of the vehicle body panel.

19. The module as claimed in claim 10 wherein the sealed cavity has a volume of less than 350 mm³.

20. The module as claimed in claim 10, wherein the adhesive member has a thickness between 0.1 mm and 0.5 mm, the structure panel has a thickness between 0.1 mm and 2.0 mm, and an area of the structure panel enclosed by the adhesive ring is equivalent to a circular area of a diameter between 10 mm to 80 mm.
